(19) United States
(12) Patent Application Publication
(10) Pub. No.: US 2005/0036174 A1
(43) Pub. Date: Feb. 17, 2005

(54) Method and apparatus for providing a noise estimation for automatic selection of dither patterns in low frequency watermarks

(76) Inventor: Jeffrey Lubin, Princeton, NJ (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(21) Appl. No.: 10/872,961

(22) Filed: Jun. 21, 2004

Related U.S. Application Data
(60) Provisional application No. 60/479,660, filed on Jun. 19, 2003.

(51) Int. Cl. H04N 1/405; H04N 1/409; G06T 5/00; G06T 7/00; G06K 9/46

(52) U.S. Cl. 358/3.14; 358/3.28; 358/3.26; 382/205; 382/228

(57) ABSTRACT

A method and apparatus for providing noise estimation for dithering pattern selection is disclosed. One or more candidate regions are identified from a source. A noise estimation is provided. A dithering pattern is introduced for a selected candidate region based on a magnitude of the noise estimation

### CROSS-REFERENCE TO RELATED APPLICATIONS

This application claims benefit of U.S. provisional patent application Ser. No. 60/479,660, filed Jun. 19, 2004, which is herein incorporated by reference.

### BACKGROUND OF THE INVENTION

For low frequency watermark embedding into low bit-depth source content (e.g., 8-bit or lower), a contouring artifact can render the watermark visible, even when the intended low frequency pattern is not. This is because even one grey-level steps are often visible.

In FIG. 1, the contrast of a one grey-level step is plotted as a function of normalized greylevel (i.e., the fraction of the complete greylevel range), for a typical display gamma and ambient (Here, gamma is 2.2, and ambient is 10% of the maximum screen luminance, however, the results do not change much for other reasonable settings.) Given that the contrast threshold for a luminance step on a uniform background is approximately 0.0075 over a broad luminance range (See for example, Jeffrey Lubin, Albert P. Pica, 1991, “A nonuniform quantizer matched to human visual performance”, Proc. SID, 619-622), the plot makes it clear that the one-greylevel steps in a low frequency watermark can be visible for 8-bit insertion, even when they would be completely invisible for 10-bit insertion.

The standard practice for combating contouring, is to modify the offending pattern itself (in this case, the embedded watermark) with a dithering pattern; i.e., with the addition of random greylevel noise. This dithering approach potentially opens up more regions within which embedding can be done successfully without loss of fidelity, thus increasing the overall bit-rate of the watermark.

However, there are potential security and fidelity concerns with the use of dithering. From a security perspective, the introduction of a dithering pattern within a fingerprint watermark provides a potential noise signature that can be used to detect and then jam or otherwise eliminate the identifying mark. Fidelity may also suffer, for similar reasons. That is, differences between the dithering pattern and other noise patterns in the source content may be visually detectable.

Needed therefore is a technique for helping to ensure that the dithering patterns used to remove visible contouring in low frequency marks do not themselves produce artifacts that are detectable to human or machine.

### SUMMARY OF THE INVENTION

In one embodiment, the present invention generally discloses a method and apparatus for providing noise estimation for dithering pattern selection. One or more candidate regions are identified from a source. A noise estimation is provided. A dithering pattern is introduced for a selected candidate region based on a magnitude of the noise estimation.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of the visibility of one-greylevel steps in a low frequency watermark;

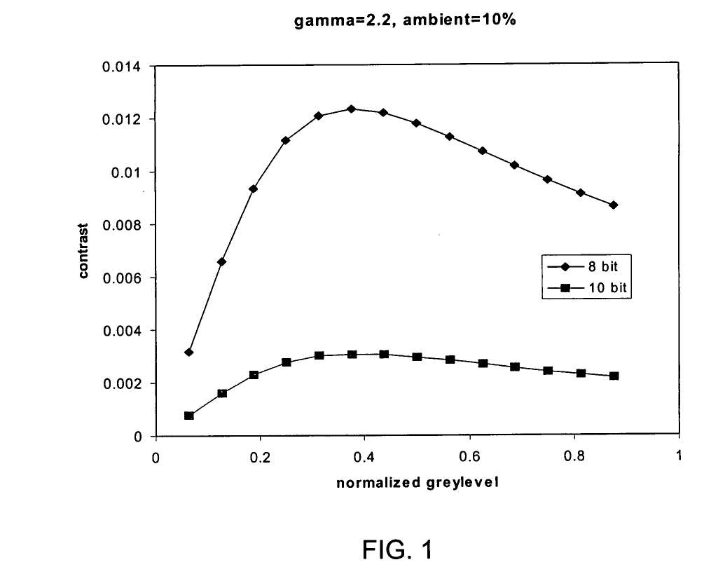

FIG. 2 illustrates an embodiment of a system in accordance with the present invention; and

FIG. 3 illustrates a flow diagram in accordance with a method of the present invention.

### DETAILED DESCRIPTION

In one embodiment, the present invention comprises a method and apparatus for estimating noise for automatic selection of dither patterns. In the following description, potential low frequency watermark regions are used, however it should be noted that the applications developed could be applied to other image-processing applications with similar characteristics.

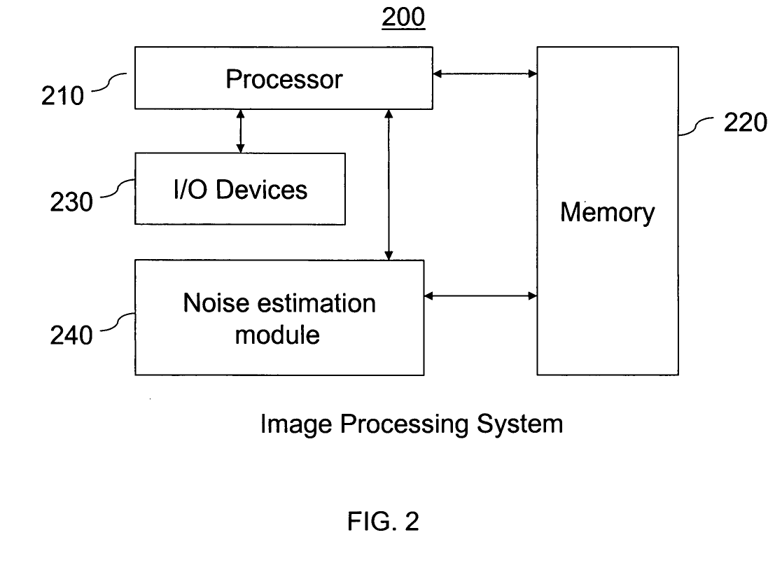

FIG. 2 illustrates a block diagram of an image processing device or system 200 of the present invention. Specifically, the system can be employed to estimate noise for automatic selection of dither patterns. In one embodiment, the image processing device or system 200 is implemented using a general purpose computer or any other hardware equivalents.

Thus, image processing device or system 200 comprises a processor (CPU) 210, a memory 220, e.g., random access memory (RAM) and/or read only memory (ROM), noise estimation module 240, and various input/output devices 230, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the noise estimation module 240 can be implemented as one or more physical devices that are coupled to the CPU 210 through a communication channel. Alternatively, the noise estimation module 240 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 220 of the computer. As such, the noise estimation module 240 (including associated data structures) of the present invention can be stored on a computer readable medium, e.g., RAM memory, magnetic or optical drive or diskette and the like.

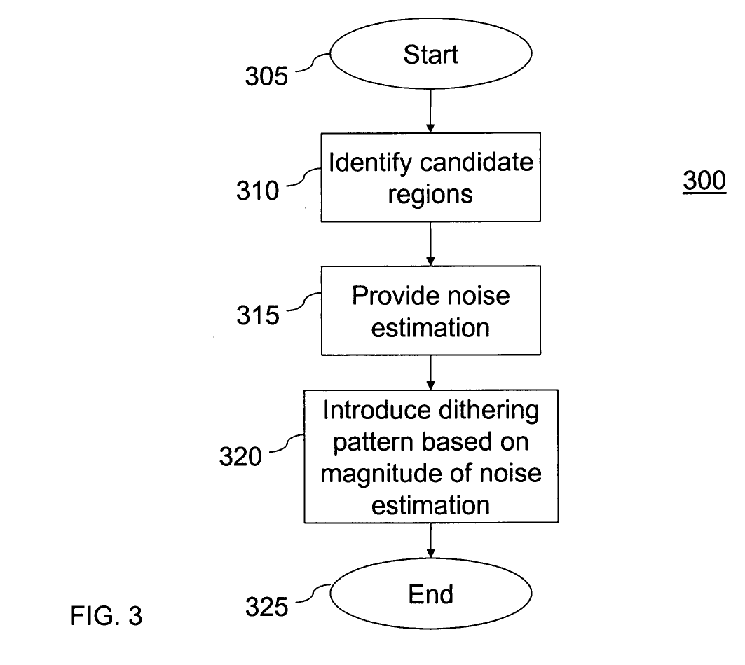

FIG. 3 illustrates a diagram in accordance with a method 300 of the present invention. Method 300 starts in step 305 and proceeds to step 310.

In step 310 candidate regions are identified from a source signal volume. In one embodiment, the candidate regions are regions where potential watermarks could be inserted into motion picture or video content. Candidate regions to be watermarked are first identified within the source signal volume (e.g., motion picture or video content), according to a maskability calculation that (a) determines if the region can support the low frequency watermark, and if so (b) estimates the noise required to mask any contouring due to low bit-depth signals. The source is then passed to a noise estimation process that calculates some noise parameters, either for these regions specifically, or for the source more generally; e.g., first through n-th order statistics of pixels and/or filtered outputs of local collections of pixels.

In step 315 noise estimation is provided. The source is passed to a noise estimation process that calculates noise parameters, either for candidate regions specifically, or for the source more generally; e.g., first through n-th order statistics of pixels and/or filtered outputs of local collections of pixels.

In one embodiment, the noise estimation is benefited by at least some initial signal estimation. One example of initial signal estimation occurs where there is reason to believe that the region to-be-estimated is meant to represent a uniform field. In this embodiment, the noise statistics may be estimated directly.

Another embodiment of initial signal estimation occurs where the region contains likely edges (as estimated from any of a large number of edge detection algorithms). In this embodiment an estimate of the signal without noise corruption can be subtracted before noise estimation proceeds.

Noise estimation need not be applied to every candidate region, but may be fruitfully applied to the source content as a whole, especially if the noise statistics do not change much throughout the content. In this embodiment, uniform regions in the content can be sought out, either automatically or through human intervention using I/O device 230 (e.g., from a region of front or end titles) and the noise estimate for the complete content is derived from these uniform regions alone.

In another embodiment separate noise estimates are derived for different luminance levels. This embodiment is useful if the noise magnitude is expected to change with signal level (e.g., if the noise is Poisson, as is the case in low light levels).

In step 320 a dithering pattern based on the magnitude of the noise estimate is introduced. If the magnitude of the estimated noise is above a region's noise threshold, as returned from the maskability calculation, then a dithering pattern that matches the statistics of the observed noise is selected for that region. In one embodiment the dithering pattern is selected using techniques introduced by Heeger and Bergen for texture synthesis. (See, for example, David J. Heeger, James R. Bergen, 1995, “Pyramid-based texture analysis/synthesis”, SIGGRAPH 1995: 229-238) If the noise threshold is not exceeded, then the candidate region is rejected from further consideration.

While the foregoing is directed to embodiments of the present invention, other and further embodiments of the invention may be devised without departing from the basic scope thereof, and the scope thereof is determined by the claims that follow.

1. A method for providing noise estimation for dithering pattern selection, comprising:
identifying one or more candidate regions from a source;
providing a noise estimation; and
introducing a dithering pattern for a selected candidate region based on a magnitude of the noise estimation.

2. The method of claim 1, wherein the candidate region is selected according to a maskability calculation.

3. The method of claim 1, wherein the step of providing the noise estimation further comprises calculating noise parameters for the selected candidate region.

4. The method of claim 1, wherein the step of providing the noise estimation further comprises calculating noise parameters for the source.

5. The method of claim 1, wherein the step of introducing a dithering pattern comprises selecting or rejecting the one or more candidate regions based on the magnitude of the noise estimation.

6. The method of claim 5, wherein the candidate regions are selected when the magnitude of the noise estimation is above a noise threshold of the candidate region.

7. The method of claim 6, wherein the dither pattern matches statistics of observed noise for the selected candidate region.

8. The method of claim 5, wherein candidate regions are rejected when the magnitude of the noise estimation is below a noise threshold of the candidate region.

9. The method of claim 2, wherein the maskability calculation determines if the candidate region can support a low frequency watermark

10. The method of claim 9, wherein the maskability calculation estimates a noise required to mask contouring.

11. The method of claim 4, wherein the noise estimation is based on a sparse selection of uniform regions.

12. The method of claim 11, wherein the uniform regions are selected automatically or by human intervention.

13. The method of claim 1, further comprising performing edge detection and subtraction before the noise estimation step.

14. The method of claim 1, wherein the dithering pattern is generated using a Heeger/Bergen texture synthesis technique.

15. The method of claim 1, wherein the noise estimation is based on Poisson noise.

16. An apparatus for providing noise estimation for dithering pattern selection, comprising:
means for identifying one or more candidate regions from a source;
means for providing a noise estimation; and
means for introducing a dithering pattern for a selected candidate region based on a magnitude of the noise estimation.

17. A computer-readable medium having stored thereon a plurality of instructions, the plurality of instructions including instructions which, when executed by a processor, cause the processor to perform the steps of a method for providing noise estimation for dithering pattern selection, comprising of:
identifying one or more candidate regions from a source;
providing a noise estimation; and
introducing a dithering pattern for a selected candidate region based on a magnitude of the noise estimation.
